(19) United States
(12) Patent Application Publication
(10) Pub. No.: US 2006/0076042 A1
(43) Pub. Date: Apr. 13, 2006

(54) Support bar for an aid for walking

(75) Inventor: Yu-Cheng Tu, Tasu Hsiang (TW)

Correspondence Address: NIKOLAI & MERSEREAU, P.A., 900 SECOND AVENUE SOUTH, SUITE 820, MINNEAPOLIS, MN, 55402, US

(73) Assignee: Yu-Chun Fang, Taipei (TW)

(21) Appl. No.: 10/960,479

(22) Filed: Oct. 7, 2004

(51) Int. Cl. A61H 3/02

(52) U.S. Cl. 135/68

(57) ABSTRACT

A support bar for an aid for walking includes a tubular part having a toothed inner wall. Multiple grooves are axially defined in the inner wall. Whereby, the overall weight of the aid for walking can be effectively decreased to enable a disabled or elderly person to use the crutch or the walking frame.

### BACKGROUND OF THE INVENTION

1. Field of the Invention

The present invention relates to an aid for walking, and more particularly to a support bar for a crutch.

2. Description of Related Art

An aid for walking, such as crutch or walking stick is used to help an elderly or disabled person. Because the user's physical strength will usually not be up to that of an average person, the overall weight of the walking aid must be as low as possible. Therefore, the conventional aid for walking is generally made of aluminum.

However, sometimes the conventional crutch made of aluminum often is still too heavy for some users. For further reducing the weight of the crutch, a support bar of the crutch is formed with a small wall thickness. However, the support bar is easily bent under a large external force because its strength is decreased in accordance with the reduced thickness.

Therefore, the invention provides a support bar for a walking aid to mitigate or obviate the aforementioned problems.

### SUMMARY OF THE INVENTION

The main objective of the present invention is to provide a support bar for an aid for walking, the support bar having a low weight yet sufficient strength.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional view of a support bar for an aid for walking in accordance with the present invention;

FIG. 2 is a perspective view of a crutch assembled with the support bar in FIG. 1; and

FIG. 3 is a perspective view of a walking frame assembled with the support bar in FIG. 1.

### DETAILED DESCRIPTION OF THE PREFERRED EMBODIMENT

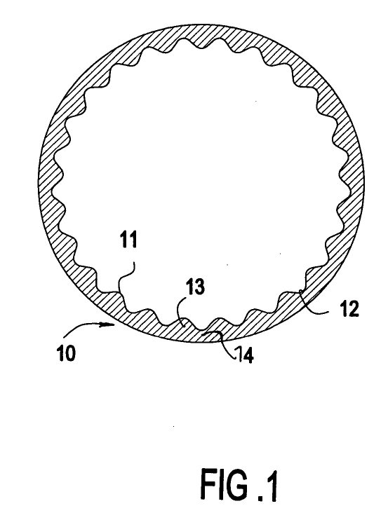

With reference to FIG. 1, a support bar (10) for an aid for walking in accordance with the present invention, is generally made of aluminum, has a tubular part. Multiple grooves (12) are axially defined in an inner wall (11) of the tubular part. Therefore, the inner wall (11) has a toothed cross section. A first wall thickness (13) of the support bar (10) is substantially equal to a wall thickness of a conventional support bar but larger than a second wall thickness (14) at the grooves (12). Therefore, the weight of the support bar (10) is decreased, yet the support bar (10) still has sufficient strength and is safe for a user.

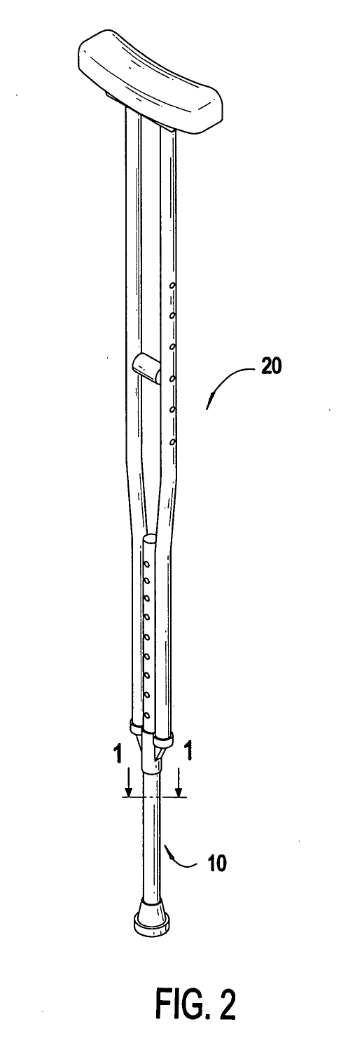

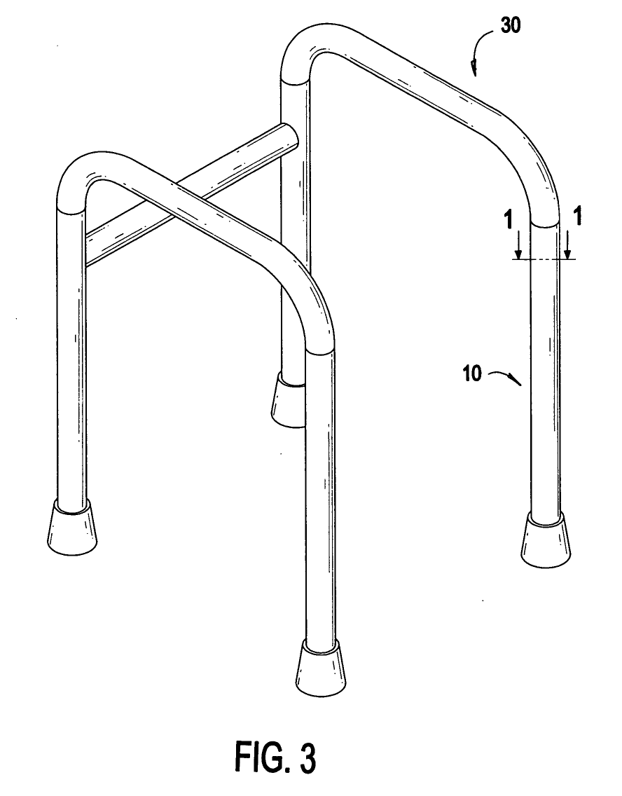

With reference to FIGS. 2-3, a crutch (20) or a walking frame (30) is assembled with the support bar (10) of the invention, so the overall weight of the crutch (20) or the walking frame (30) is decreased to enable a disabled or elderly person to use the walking aid.

By using the support bar according to the present invention, the overall weight of the aid for walking can be effectively decreased to enable the disabled or elderly person to use the crutch (20) or the walking frame.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A support bar for an aid for walking comprising:
a tubular part having a toothed inner wall (11) with multiple grooves (12) axially defined in the inner wall (11).
